(19) United States
(12) Patent Application Publication
(10) Pub. No.: US 2007/0108661 A1
(43) Pub. Date: May 17, 2007

(54) CLAMPING UNIT FOR AN INJECTION MOLDING MACHINE, AND METHOD FOR OPERATING SUCH A CLAMPING UNIT

(75) Inventors: MATTHIAS KANTER, OBERTREBRA (DE); KERSTIN HENKE, GROSSOBRINGEN (DE)

Correspondence Address: Henry M. Feiereisen;Henry M. Feiereisen, LLC, Suite 4714, 350 Fifth Avenue, New York, NY, 10118, US

(73) Assignee: Demag Ergotech GmbH, Schwaig (DE)

(21) Appl. No.: 11/558,192

(22) Filed: Nov. 9, 2006

(30) Foreign Application Priority Data
Nov. 11, 2005 (DE) 10 2005 053 802.9

(51) Int. Cl. B29C 45/64

(52) U.S. Cl. 264/328.1; 425/589

(57) ABSTRACT

A clamping unit for an injection molding machine includes a drive mechanism for moving a moving platen of the injection molding machine in at least one direction. The clamping unit has a clamping cylinder for movably receiving a clamping piston which defines a piston chamber in the clamping cylinder, and a compensating cylinder for movably receiving a compensating piston which defines a compensating chamber in the compensating cylinder. The piston chamber of the clamping cylinder and the compensating chamber of the compensating cylinder are fluidly connectable by a direct, controllable connection so that fluid can shuttle back and forth between the clamping and compensating chambers during opening and closing of the clamping unit.

### CROSS-REFERENCES TO RELATED APPLICATIONS

This application claims the priority of German Patent Application, Serial No. 10 2005 053 802.9, filed Nov. 11, 2005, pursuant to 35 U.S.C. 119(a)-(d), the content of which is incorporated herein by reference in its entirety as if fully set forth herein.

### BACKGROUND OF THE INVENTION

The present invention relates to a clamping unit for an injection molding machine, and to a method of operating such a clamping unit.

Nothing in the following discussion of the state of the art is to be construed as an admission of prior art.

Clamping units for injection molding machines are typically provided to close an injection mold having half-molds mounted onto platens, which approach one another, when closing the mold, and to apply the required clamping pressure. When the mold is closed, i.e. when the platens are moved together, the half-molds delineate a cavity into which for example thermoplastic material is injected while the clamping pressure is applied. After the injected material has solidified and hardened to form the molded article, the half-molds are opened by moving the platens apart and the molded article is removed. Typically, one of the platens is movable while the other platen is fixed.

Also known are three-platen constructions which have a support platen, a fixed platen, and a moving platen which is disposed between the support platen and the fixed platen and movable to and from in relation to the fixed platen. Normally, the moving platen is guided on columns or tie rods which also provide a force transmission between the support platen and the fixed platen. Movement of the moving platen may be realized, for example, mechanically, hydraulically or combinations of various drive mechanisms.

U.S. Pat. No. 5,129,806 discloses a hydraulic system in an injection molding machine to implement speed and pressure patterns of the closing movement during closing of the mold by employing at least three consecutive control positions with the aid of a 4/4-way valve. Using several directional control valves, different pressure chambers can be set under pressure and control positions of valve can be influenced. This type of hydraulic system is very complicated as far as mechanical structure and control operations are concerned because, i.a., a multiplicity of sensors and actuators must be individually controlled.

It would therefore be desirable and advantageous to provide an improved clamping unit for an injection molding machine, which obviates prior art shortcomings and is simple in structure while yet being reliable in operation and easy to operate.

### SUMMARY OF THE INVENTION

According to one aspect of the present invention, a clamping unit for an injection molding machine includes a drive mechanism for moving a moving platen of the injection molding machine in at least one direction, a clamping cylinder, a clamping piston movably supported in the clamping cylinder and defining a piston chamber in the clamping cylinder, at least one compensating cylinder, a compensating piston movably supported in the compensating cylinder and defining a compensating chamber in the compensating cylinder, and a direct, controllable connection between the piston chamber of the clamping cylinder and the compensating chamber of the compensating cylinder.

The present invention resolves prior art problems by the provision of a direct connection between the piston chamber and the compensating chamber, whereby a flow of fluid, such as hydraulic oil, through the connection can be made or cut. Suitably, when the moving platen is moved and a connection is established between the piston chamber and the compensating chamber, an exchange of fluid is possible between these chambers. Thus, fluid can be kept substantially in the system formed by the clamping cylinder and the compensating cylinder.

According to another feature of the present invention, the clamping unit may include a single clamping cylinder with accommodated clamping piston, and two compensating cylinders with respectively accommodated compensating pistons. Suitably, the single clamping cylinder occupies hereby a central disposition with respect to the moving platen, with the compensating cylinders disposed in diagonal relationship to the clamping cylinder. The direct, controllable connection is hereby provided between the piston chamber of the clamping cylinder and the compensating chambers of both compensating cylinders.

According to another feature of the present invention, the clamping unit may include two clamping cylinders and a single compensating cylinder which is disposed in midsection of the moving platen, with the direct, controllable connection being provided between the piston chambers of both clamping cylinders and the compensating chamber of the compensating cylinder.

According to another feature of the present invention, the clamping unit may include two clamping cylinders and two compensating cylinders, with the direct controllable connection being provided either between both piston chambers of the clamping cylinders and both compensating chambers of the compensating cylinders, or also between one piston chamber and one compensating chamber, respectively.

Of course, the number and relative disposition of clamping cylinders and compensating cylinders can be selected and suited in dependence on the need at hand and on the required clamping forces and other parameters.

According to another feature of the present invention, the piston chamber of the clamping cylinder is a high-pressure chamber which is under high pressure to apply the clamping pressure when the platens are closed. As a result, the fluid in the piston chamber can be transferred, at least partly, to the compensating chamber of the compensating cylinder by suitably switching the connection between the piston chamber and the compensating chamber during movement of the moving platen.

According to another feature of the present invention, the direct, controllable connection between the piston chamber of the clamping cylinder and the compensating chamber of the compensating cylinder can be implemented by a connection line and a shut-off valve disposed in the connection line. The provision of a connection line is easy to implement in order to establish the direct, controllable connection between the piston chamber and the compensating chamber. In the event the clamping unit is constructed with several clamping cylinders and several compensating cylinders, the connection between the piston chambers and the compensating chambers can easily be realized by means of such connecting lines. Suitably, the connecting line(s) should be selected not too long, and the diameter should be selected in dependence of the fluid amounts being transported.

According to another feature of the present invention, the clamping cylinder and the clamping piston as well as the compensating cylinder and the compensating piston can be constructed in such a manner that a change in volume in the compensating chamber is in inverse relationship to a change in volume in the piston chamber of the clamping cylinder, when the moving platen is moved. Thus, during an opening movement of the clamping unit, the piston chamber can be reduced in size while at the same time the compensating chamber is increased in size. Thus, a linkage is established between the change in volume of piston chamber and compensating chamber. Suitably, the change in volume in the compensating chamber is substantially inversely proportional/identical to the change in volume in the piston chamber of the clamping cylinder. This ensures that fluid in the chambers remains essentially in the system so that only little amount of new fluid is required to be replenished despite the numerous opening and closing movements that the clamping unit undergoes. In particular, when the piston chamber is a high-pressure chamber, it becomes possible to use a pump with little pump capacity for setting the piston chamber under pressure in the closing position, as the pump is required to pump only small fluid amounts, the so-called compression portion. The pumping action for supply of this compression portion during each buildup of clamping pressure ensures also a sufficient fluid exchange to counter heating or contamination of the fluid.

The compensating chamber, which constitutes a piston chamber of the system comprised of compensating cylinder and compensating piston, assumes a kind of storage function or also transfer function. For example, when the clamping unit undergoes a closing movement, fluid displaced directly from the compensating chamber as a result of a negative change in volume can be directly transferred to the piston chamber of the clamping cylinder via the controllable connection. The provision of the direct connection eliminates or at least substantially reduces the likelihood of any leakage. In the unlikely event of a leakage, resultant fluid loss can be easily compensated during a subsequent pressure admission by the compression portion.

According to another feature of the present invention, the clamping piston and the compensating piston can be fixedly secured to one another. This linkage may be realized for example by articulating both the clamping piston and the compensating piston to the moving platen. As an alternative, the clamping piston and the compensating piston may also be coupled in an area of a machine bed or a support platen while the clamping cylinder and the compensating cylinder can then be attached to the moving platen. As a consequence of this forced linkage, there is no need for providing a series connection of individual cylinders so that a possible tendency of hydraulic fluid in the cylinder chambers to vibrate can be effectively prevented. The rigid connection of both pistons also contributes to a simplification of the overall construction of the clamping unit and facilitates the control circuit also because of the reduced vibration tendency of the fluid column in the various piston chambers.

In the event the clamping piston and the compensating piston are fixedly articulated to the moving platen, the piston chamber of the clamping cylinder may be mounted on the side distal to the moving platen while the compensating chamber of the compensating cylinder is disposed on the side proximal to the moving platen. As the moving platen is moved in a closing direction, i.e. away from the clamping and compensating cylinders, the piston chamber thus increases in size while the compensating chamber is reduced in size as a consequence of the rigid connection between both pistons. This ensures an inverse relationship with respect to the volume change in the piston chambers whereby the inverse relationship can be identical, when the piston chambers are suitably constructed. The compensating chamber can thus assume the function of a reservoir for fluid required in the piston chamber during mold closure. The movement of the compensating piston in the compensating cylinder is comparable to a kind of transfer function as the movement causes fluid from the compensating chamber to flow to the piston chamber of the clamping cylinder.

According to another feature of the present invention, a multiway valve may be provided by which the piston chamber of the clamping cylinder can be connected via a pressure line to a pressure source for producing a clamping pressure, or to a tank, or by which the piston chamber of the clamping cylinder can be isolated from the hydraulic system. Thus, the multiway valve can be closed during closing movement or opening movement of the clamping unit so that the pressure line is isolated and a fluid transfer can be established between compensating chamber and piston chamber via the connection which in this case is switched to open. Once the closing movement is over and the mold is closed, the multiway valve can be switched to establish a connection of the pressure line to a pressure source, such as a pump or a pressure line of a hydraulic system. At the same time, the connection between the piston chamber and the compensating chamber is suitably closed to prevent the compensating chamber from being pressurized. The piston chamber, constituting a high-pressure chamber of the clamping cylinder, is set under pressure and is thus able to apply the clamping pressure. The compensating chamber may hereby be connected to a tank or tank line of the hydraulic system to prevent excessive pressure buildup therein. At the same time, pressure can be equalized in the compensating chamber. During movement of the moving platen, the compensating chamber can be connected simultaneously with the tank line of the hydraulic system to compensate potential volume fluctuations of the fluid for example as a result of temperature changes or the like. In particular during opening movement, a connection between the system of compensating chamber and piston chamber with the tank or tank line can be of advantage in order to drain a fluid amount corresponding to the compression portion of the clamping pressure buildup from the system into the tank. This connection to the tank may also be realized via the multiway valve. A non-return valve may hereby be disposed in the return line to prevent excessive flow of fluid back into the tank.

Connecting the piston chamber to a tank or tank line of a hydraulic system may also be of advantage during finishing works such as shutdown of the clamping unit, because fluid is able to flow into the tank during an opening movement, when the connection to the compensating chamber is cut. A connection to the tank may also be of advantage for example during operation and open connection between the piston and compensating chambers to enable a fluid exchange.

At cyclic operation of the clamping unit according to the invention, the small amount of fluid being replenished during application of the clamping pressure may be sufficient to ensure a sufficiently thorough mixture of the fluid in the absence of any leakage, and to keep fluid contamination and fluid temperature within the operating range. Thus, the so-called compression portion during buildup of the clamping pressure and the discharge of a respective fluid amounts during the subsequent opening movement into the tank can ensure a sufficient fluid exchange. Any leakage loss or possible fluid excesses can be compensated by respective connections to the tank.

According to another feature of the present invention, the clamping cylinder may have a further piston chamber which is selectively connectable via a supply line to a pressure source for effecting an opening movement or to a tank or tank line of a hydraulic system. Pressurizing the further piston chamber of the clamping cylinder opens the clamping unit. This is useful especially when a single-action drive mechanism is used which acts only in closing direction. During such opening movement, the controllable connection between the piston chamber and compensating chamber can be open so that fluid in the piston chamber can be essentially transferred to the compensating chamber. Suitably, the compensating chamber fluidly communicates with the tank to enable a drainage of excess fluid.

The clamping piston may be constructed in the form of a double-action piston, whereas the further piston chamber may constitute a ring space which surrounds the piston rod of the clamping piston. The further piston chamber of the clamping cylinder may hereby be dimensioned with small effective piston surfaces so that only little amounts of fluid are required to generate the movement of the clamping unit. During closing movement of the clamping unit in opposite direction, the further piston chamber of the clamping cylinder can be connected to a tank so that fluid displaced by the further piston chamber can be transferred to the tank as a result of the decrease in volume.

According to another feature of the present invention, the compensating cylinder has a cylinder wall, in particular an end cover, with the drive mechanism being mounted to the cylinder wall, on one hand, and to the compensating piston, on the other hand. This disposition of the drive mechanism ensures a compact configuration of the clamping unit according to the invention because the drive mechanism can be arranged essentially in an area of the compensating cylinder which is not or not necessarily filled with fluid during operation. The compensating cylinder may be arranged upon a fixed machine element such as a support platen or a machine bed while the compensating piston can be movably supported relative thereto and connected for example to the moving platen so that the drive mechanism is able to act precisely between these moving and fixed elements.

According to another feature of the present invention, the drive mechanism may include an active piston. The active piston may be a single-action piston to effect a closing movement only, or a double-action piston to effect closing and opening movements. Suitably, the active piston may be hydraulically operated so that the hydraulic system already provided for generating the clamping force can be utilized for the operation of the active piston as well. Of course, it also conceivable as a result of different capacity demands to provide several pumps for pressurizing the chambers of the various pistons.

According to another feature of the present invention, the active piston may be attached to a cylinder wall or an end cover of the compensating cylinder, with the compensating piston having a piston chamber, separated from the compensating chamber by the compensating cylinder, for receiving the active piston. In this way, the drive mechanism can be integrated in the clamping unit in a particularly space-saving and compact manner. The provision of the piston chamber for the active piston in the compensating piston eliminates the need for an additional cylinder for the active piston. The active piston may include a longitudinal bore for fluid supply of the piston chamber of the active piston. The active piston may be constructed relatively small in diameter as it is not required to transmit great forces. During opening and closing movements, the active piston plunges into the piston chamber in the compensating piston.

According to another feature of the present invention, the drive mechanism may be constructed as a spindle drive comprised of a spindle nut and a spindle which is in engagement with the spindle nut. Such a spindle drive is able to convert a rotational movement of one of the two elements, i.e. spindle or spindle nut, to a linear movement and is useful when rapid movements are wanted. The spindle drive may be used to implement both the opening and closing movements of the clamping unit so that the need for a further hydraulic consumer is eliminated and the overall hydraulic system can be smaller in size.

According to another feature of the present invention, the spindle may be arranged on the compensating piston, and the spindle nut may be rotatably supported on a cylinder wall or end cover of the compensating cylinder. This results in a particularly space-saving and compact drive which is able to assume a movement of the clamping unit in both opening and closing directions. To prevent damage to the spindle drive when the mold is closed and the full clamping pressure is applied, at least one of the elements, spindle or spindle nut, may be arranged with play. For example, the spindle may be arranged with play upon the compensating piston by means of an annular spring or the like for example, or the spindle nut may be movably supported to allow a slight shift of the spindle nut in axial direction.

As an alternative, the spindle may be rotatably supported on the cylinder wall or end cover of the compensating cylinder and the spindle nut may be arranged on the compensating piston, with the compensating piston including a recess for allowing the spindle to plunge into. The spindle may be supported with axial play and/or the spindle nut may be arranged on the compensating piston for slight shift, for example through intervention of a spring mechanism, so as to minimize stress to the spindle drive when the clamping force is applied. The spindle nut may hereby be placed upon the compensating piston or received interiorly therein. In the latter case, the compensating piston is formed with a recess for allowing the tip of the spindle to plunge into the recess during relative movement between the spindle and the spindle nut. This construction is compact because the spindle is able to plunge into the compensating piston and is not projecting out of the compensating cylinder.

Of course, several spindle drives may be provided as well when several compensating cylinders are involved for interaction with all or less than all of the compensating cylinders.

According to another feature of the present invention, the spindle drive may include an electric motor, e.g. a servo motor, for driving the spindle or the spindle nut. A characteristic of an electric motor is its low inertia so that a rapid displacement and high reactive speed are ensured. The use of a servo motor results in a precise operation also with respect to location.

According to another feature of the present invention, the electric motor may be a direct drive. The term “direct drive” is to be understood as a drive having a driveshaft which coincides with the rotor axle, with or without interposition of a transmission such as a planetary gear train. A direct drive is characterized by a compact structure and absence of an axle offset. In the event a high-speed operation is desired, the use of a high-torque direct drive may be appropriate. Suitably, the electric motor is mounted to a cylinder wall or end cover of the compensating cylinder, thereby further contributing to an overall compact construction.

According to another feature of the present invention, a pump may be flange-mounted to the electric motor for producing the clamping force. Using appropriate coupling mechanisms, freewheels or other suitable measures enable the electric motor to drive the pump to generate the clamping force as well as the spindle drive to implement the displacement of the clamping unit. As a result of the dual function of the electric motor, the need for a separate motor for the pump is eliminated, thereby reducing costs.

A clamping unit according to the present invention is simple in structure and compact. The simple construction of the mechanical components as well as the pressure fluid system also allows a simple configuration of the control unit for the clamping unit. There is no unwanted vibration so that the operation is especially economical as the need for providing energy-intensive damping measures can be substantially eliminated. Operation of the clamping unit is safe and reliable and little maintenance is required. The need for sensors and actuators for regulating a fluid amount and for ascertaining the pressure in some areas can be eliminated. The pump controller can be constructed to determine and consider all relevant signals and measuring values of the fluid while leakage or excess fluid can be compensated by the connections to the pump and the tank. Compactness is especially beneficial for small machines.

According to another aspect of the present invention, a method of operating a clamping unit of an injection molding machine having a moving platen includes the step of directly fluidly connecting a piston chamber of a clamping cylinder of the clamping unit with a compensating chamber of a compensating cylinder of the clamping unit to allow fluid displaced from one of the piston chamber and the compensating chamber to substantially flow to the other one of the piston chamber and the compensating chamber, when the moving platen is moved.

The provision of a direct flow communication between the piston chamber of the clamping cylinder and the compensating chamber of the compensating cylinder is beneficial because no fluid in the system gests lost but is merely shuttled back and forth. This positively affects the dimension of the hydraulic system and the pump capacity. The direct fluid communication also avoids fluid transfers over long distances and results in a positive force balance.

In accordance with the invention, it is thus also possible to use one clamping cylinder and two compensating cylinders for interaction, or two clamping cylinders with two compensating cylinders.

According to another feature of the present invention, a fluid communication between the piston chamber of the clamping cylinder and the compensating chamber of the compensating cylinder can be cut, when the clamping unit is locked and the clamping pressure is applied, and the piston chamber of the clamping cylinder is set under pressure. Thus, the piston chamber of the clamping cylinder can be operated during locking with only a small amounts of added fluid, the so-called compression portion, in order to generate a sufficiently high clamping pressure. There is no need for providing a pump with large flow rate because a major part of fluid in the piston chamber has been shuttled from the compensating cylinder back to the clamping cylinder during displacement of the clamping unit and thus remains in the system. Energy consumption of the system is thus reduced and there is no need for using pressure sensors in the area of the piston chamber in the event a variable capacity pump is used because the pump controller for such a pump can be utilized for determining the respective pressure.

Fluid still present in the compensating chamber after cutting the fluid communication to the piston chamber is slightly compressed when the piston chamber is under pressure. It is, however, also possible to connect the compensating chamber during this time with a tank or tank line of the hydraulic system to avoid the presence of an excess pressure buildup in the compensating chamber and to attain a pressure equilibrium. The compensating chamber may be connected, at least during opening movement, with the tank or tank line to offset fluid excess, volume fluctuations or possible leakage.

According to another feature of the present invention, an active piston chamber may be set under pressure, when closing the clamping unit, and connected to a tank or tank line, when opening the clamping unit. By arranging a movably supported active piston in the active piston chamber, the closing movement of the clamping unit is easy to implement and requires little fluid.

According to another feature of the present invention, a further piston chamber of the clamping cylinder can be pressurized when the clamping unit opens. This may be of advantage, when the active piston is of the single-action type, and the further piston chamber of the clamping cylinder can be sized in such a way that the opening movement also requires little amount of fluid so that the active piston chamber as well as the further piston chamber of the clamping cylinder can be operated from a same pressure source.

According to another feature of the present invention, opening and closing of the clamping unit may be realized by means of a spindle drive comprised of a spindle and-spindle nut. The use of an electromotive operation of the spindle drive is as reliable as a hydraulic operation with respect to speed and consumed energy but has the added benefit of being simple in structure as the number of pumps and the pump capacity are reduced. Using a servo motor in particular also allows a precise positioning of the moving platen and a determination of the actual position of the moving platen.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of one embodiment of a clamping unit according to the present invention in idle state;

FIG. 2 is a schematic illustration of another embodiment of a clamping unit according to the present invention in movement state; and

FIG. 3 is a schematic illustration of still another embodiment of a clamping unit according to the present invention in movement state.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

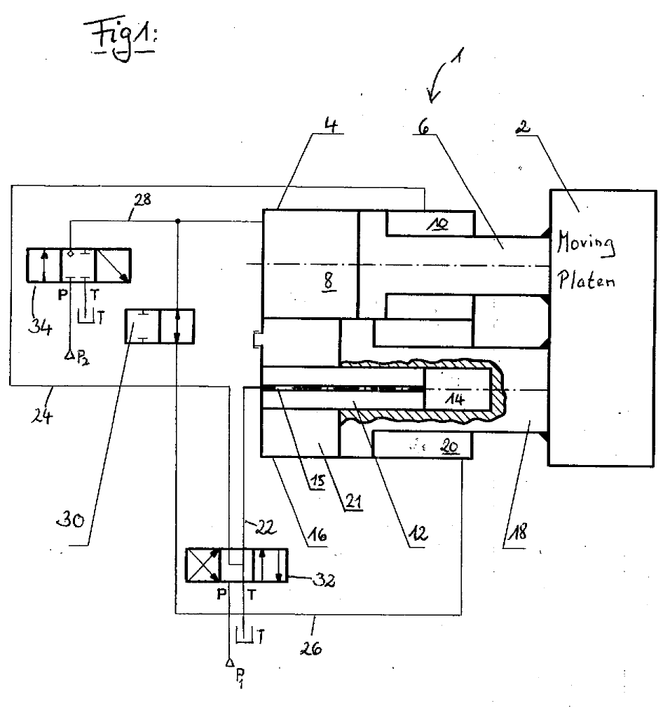

Turning now to the drawing, and in particular to FIG. 1, there is shown a schematic illustration of one embodiment of a clamping unit according to the present invention, generally designated by reference numeral 1 and forming part of an injection molding machine which includes a moving platen 2 but otherwise is not shown in greater detail for the sake of simplicity. The moving platen 2 may be guided by tie rods and/or on rails. Mounted, e.g. welded, to the moving platen 2 is a clamping piston 6 which is movably received in a clamping cylinder 4 and divides the clamping cylinder 4 in a piston chamber 8 and a piston chamber 10 which are sealed from one another.

Further mounted, e.g., welded, onto the moving platen 2 is a compensating piston 18 which is movably received in a compensating cylinder 16 and defines a compensating chamber 20 and a further piston chamber 21within the compensating cylinder 16. The compensating chamber 20 is hereby formed as a ring-shaped space by way of example. The clamping cylinder 4 and the compensating cylinder 16 are interconnected or arranged onto a same mounting (not shown), for example a support platen or a machine bed. Formed interiorly of the compensating piston 18 is an active piston chamber 14 into which an active piston 12 projects. The active piston 12 is mounted to an end cover of the compensating cylinder 16 and includes a longitudinal bore 15 via which the active piston chamber 14 can be supplied with fluid via a feed line 22.

The piston chamber 10 of the clamping cylinder 4 is supplied with fluid via a supply line 24. Both the feed line 22 and the supply line 24 can be selectively connected via a multiway valve 32 to a pump P₁ or a tank T or connected at the same time to the tank T. FIG. 1 shows the idle state when both feed line 22 and supply line 24 fluidly communicate with the tank T.

The piston chamber 8 of the clamping cylinder 4 and the compensating chamber 20 of the compensating cylinder 16 are fluidly connected via a direct, controllable connection comprised of a connection line 26 and a shutoff valve 30 which is disposed in the connection line 26 for cutting or allowing a flow of fluid through the connection line 26. The piston chamber 8 of the clamping cylinder 4 and the compensating chamber 20 of the compensating cylinder 16 are configured such as to have an essential inverse relationship with respect to a volume change when the clamping piston 6 and the compensating piston 18 and thus the moving platen 2 are moved in relation to the clamping cylinder 4 and the compensating cylinder 16. In other words, the piston chamber 8 and the compensating chamber 20 are inversely proportional so that an increase in volume in one of the chambers 8, 20 is accompanied in a decrease in volume in proportion or by the same factor in the other one of the chambers 8, 20. As a result, fluid is able to flow from one of the chambers 8, 20 into the other one of the chambers 8, 20 during a movement of the platen 2, without encountering pressure peaks or losses.

A pressure line 28 is provided to selectively connect the piston chamber 8 of the clamping cylinder 4 by means of a multiway valve 34 disposed in the pressure line 28 with a pressure source such as a pump P₂ for pressurizing the pressure chamber 8, or with a tank T, or to isolate the piston chamber 8. Although the foregoing description differentiates between pumps P₁ and P₂ for ease of understanding, it is, of course, conceivable that a same pump is involved, i.e. both multiway valves 32, 34 are connectable to a same pressure source.

When the moving plate 2 is caused to travel in closing direction, i.e. to the right in FIG. 1, the multiway valve 32 is switched to fluidly connect the feed line 22 with the pump P₁ and to fluidly connect the supply line 24 with the tank T. At the same time, the shutoff valve 30 is switched to the open disposition to fluidly connect the piston chamber 8 of the clamping cylinder 4 and the compensating chamber 20 of the compensating cylinder 16 via the connection line 26, while the multiway valve 34 isolates the pressure line 28 from the pump P₂ as well as from the tank T. As fluid is admitted into the active piston chamber 14 of the active piston 12 via the feed line 22 to set the active piston chamber 14 under pressure, the moving platen 2 as well the clamping piston 6 and the compensating piston 18 as a result of their forced interconnection are moved to the right. This movement causes a decrease in volume of the compensating chamber 20 and an increase in volume of the piston chamber 8. Fluid is thus displaced from the compensating chamber 20 and flows substantially to the piston chamber 8. Thus, the compensating chamber 20 and the piston chamber 8 are evenly filled at all times, thereby preventing fluid columns to vibrate in view of the interconnection of the clamping piston 6 and the compensating piston 18.

As soon as the moving platen 2 reaches the closing position, the so-called mold closure, pressure buildup commences, also called the locking phase. In this phase, the shutoff valve 30 is closed and the connection line 26 between the piston chamber 8 of the clamping cylinder 4 and the compensating chamber 20 of the compensating cylinder 16 is cut. The multiway valve 32 is switched to fluidly connect the active piston chamber 14 of the active piston 12 as well as the piston space 10 of the clamping cylinder 4 to the tank T. In addition, the compensating chamber 20 may be connected via a not shown valve to a tank line of the hydraulic system. Subsequently, the multiway valve 34 is switched to connect the pressure line 28 to the pump P₂ so that fluid is admitted into the piston chamber 8 of the clamping cylinder 4. As the shutoff valve 30 is closed, pressure can build up in the piston chamber 8 to provide the clamping pressure.

In order to open the clamping unit 1, the shutoff valve 30 is opened to fluidly connect the piston chamber 8 and the compensating chamber 20. The multiway valve 34 is closed to isolate the pressure line 28 while the connection of the compensating chamber 20 to the tank line is maintained. As an alternative, it is also possible to switch the multiway valve 34 in such a way as to fluidly connect the pressure line 28 and the tank line to allow drainage of excess fluid. The multiway valve 32 is then switched to fluidly connect the feed line 22 to the piston chamber 14 of the active piston 12 with the tank T of the hydraulic system and to fluidly connect the piston chamber 10 of the clamping cylinder 4 with the pump P₁ or a pressure line thereof via the supply line 24. As a result, pressure builds up in the piston chamber 10 of the clamping cylinder 4 to effect a travel of the moving platen 2 to the left in FIG. 1.

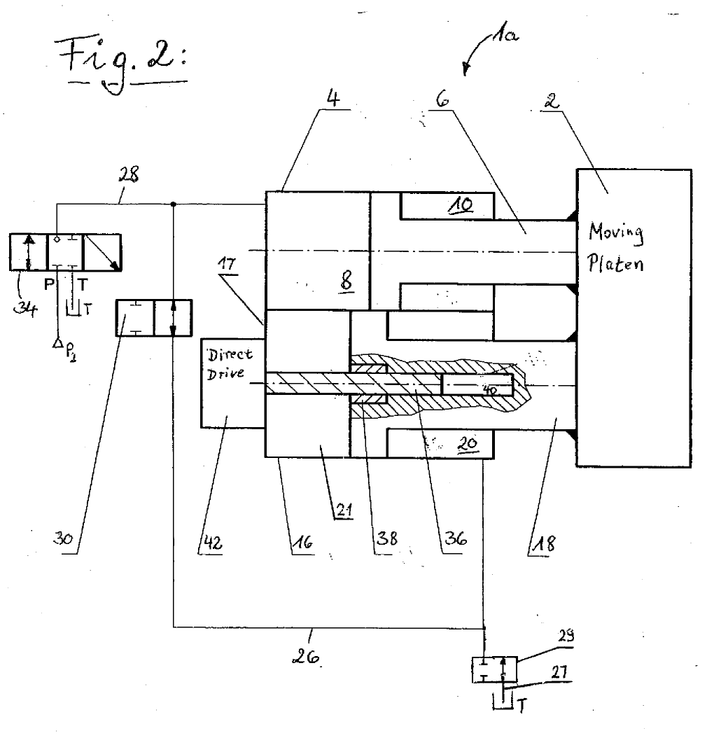

Referring now to FIG. 2, there is shown a schematic illustration of another embodiment of a clamping unit according to the present invention, generally designated by reference numeral 1a. Parts corresponding with those in FIG. 1 are denoted by identical reference numerals and not explained again. The description below will center on the differences between the embodiments. In this embodiment, provision is made for a spindle drive, instead of a hydraulic drive, to effect a movement of the platen 2. The spindle drive includes a spindle 36 which is rotatably supported in a cylinder wall or end cover 17 of the compensating cylinder 16 and engages a spindle nut 38 which is arranged on the compensating piston 18. Suitably, the spindle nut 38 is secured to the compensating piston 18 with slight play. The spindle 36 extends into a recess 40 which is formed in the compensating piston 18.

A direct drive 42 rotates the spindle 36 to cause the spindle nut 38 and thus the compensating piston 18 to move in axial direction in relation to the compensating cylinder 16. In view of the fixed connection with the compensating piston 18, the platen 2 and the clamping piston 6, which is securely fixed to the platen 2, are moved. In this embodiment, neither the piston chamber 21 of the compensating cylinder 16 nor the recess 40 in the compensating piston 18 nor the piston chamber 10 of the clamping piston 4 are exposed to hydraulic fluid. Only the piston chamber 8 of the clamping cylinder 4 and the compensating chamber 20 of the compensating cylinder 16 are filled with fluid and directly connectable via the connection line 26.

A movement of the platen 2 in opening and closing directions is realized through operation of the spindle drive. The shutoff valve 30 is hereby switched to open, thereby establishing a fluid communication between the piston chamber 8 and the compensating chamber 20. Pressure line 28 is isolated from the hydraulic system through suitable switching of the multiway valve 34. When an opening movement of the platen 2 is involved, the multiway valve 34 can also be configured to provide a fluid communication of the pressure line 28 with the tank T for drainage of excess fluid. A connection may also be provided between the compensating chamber 20 and a tank line 27 that leads to the tank T via a shutoff valve 29. When the direct drive 42 rotates the spindle 36, the platen 2 is caused to move in a direction that depends on the direction which the spindle 36 rotates. A movement by the platen 2 in opening or closing directions is accompanied by a respective fluid transfer between the piston chamber 8 and the compensating chamber 20 via the connection line 26 in one or the other direction.

As soon as the platen 2 has reached the closing position, a right-hand end position in FIG. 2, the locking phase commences as follows: The shutoff valve 30 is closed to cut the connection between the piston chamber 8 and the compensating chamber 20, and the multiway valve 34 is switched to connect the pressure line 28 with the pressure source P₂. The compensating chamber 20 is connected during this phase to a tank line. As a result, pressure builds up in the pressure chamber 8 of the clamping cylinder 6 to provide the clamping pressure. As the spindle nut 38 is mounted with play in relation to the compensating piston 18 and/or the spindle 36 is mounted with axial play in relation to the compensating cylinder 16, the risk of damage to the spindle drive and overall drive mechanism is eliminated when the full clamping pressure is applied upon the clamping piston 6.

When subsequently opening the clamping unit 1a, the pressure line 28 is isolated again from the hydraulic system, and the shutoff valve 30 is opened to fluidly connect the piston chamber 8 and the compensating chamber 20, while the connection between the tank line and the compensating chamber 20 is maintained. As an alternative, this connection may also be cut and the pressure line 28 may be connected to the tank line. Either way, a respective rotation of the spindle 36 moves the platen 2 to the left in FIG. 2.

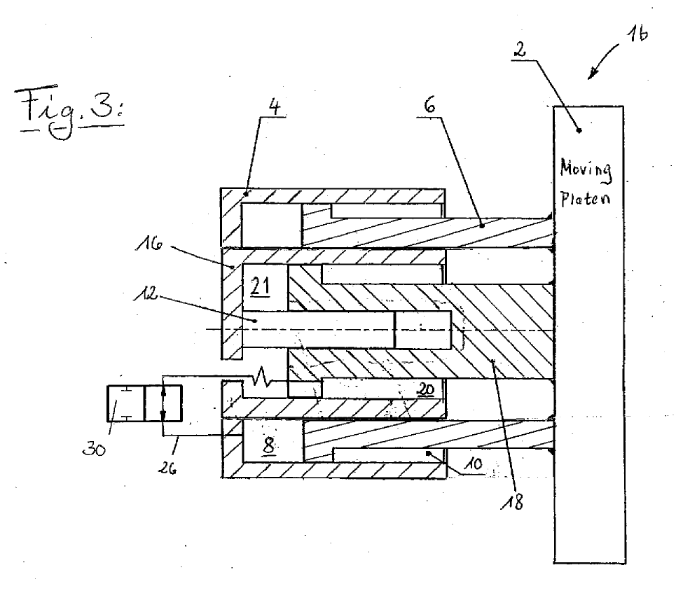

Referring now to FIG. 3, there is shown a schematic illustration of another embodiment of a clamping unit according to the present invention, generally designated by reference numeral 1b. Parts corresponding with those in FIG. 1 are denoted by identical reference numerals and not explained again. The description below will center on the differences between the embodiments. In this embodiment, provision is made for a symmetric disposition of compensating cylinder 16 and compensating piston 18 in relation to clamping cylinder 4 and clamping piston 6. Both the clamping piston 6 and compensating piston 18 are again interconnected via the moving platen 2. The clamping cylinder 4 is arranged in surrounding concentric relationship to the compensating cylinder 16. Movement of the platen 2 in mold-closing direction is implemented by the active piston 12 and in mold-opening direction by the clamping piston 6, as described with reference to the clamping unit 1 of FIG. 1. Of course, the clamping unit 1b may be provided instead with a spindle drive to effect the opening and closing movements. The clamping unit 1b has a connection line 26, which in this embodiment extends through the piston chamber 21 of the compensating cylinder 16, for fluidly connecting the compensating chamber 20 with the piston chamber 8 of the clamping cylinder 4. The piston chamber 8 is hereby configured as annular space. The connection line 26 is length-adjustable and may be constructed for example in the form of longitudinal bores provided in the compensating piston 18 and in the clamping piston 6 and interconnected at a free zone by a suitable connection piece. The symmetric configuration of the clamping unit 1b attains a particularly advantageous force balance. Operation of the clamping unit 1b corresponds to the operation of the clamping unit 1 so that further description thereof is omitted for the sake of simplicity.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A clamping unit for an injection molding machine, comprising:
a drive mechanism for moving a moving platen of the injection molding machine in at least one direction;
at least one clamping cylinder;
a clamping piston movably supported in the clamping cylinder and defining a piston chamber in the clamping cylinder;
at least one compensating cylinder;
a compensating piston movably supported in the compensating cylinder and defining a compensating chamber in the compensating cylinder; and
a direct, controllable connection between the piston chamber of the clamping cylinder and the compensating chamber of the compensating cylinder.

2. The clamping unit of claim 1, further comprising a further said compensating cylinder, wherein the clamping cylinder occupies a central disposition with respect to the moving platen, with the two compensating cylinders disposed in diagonal relationship to the clamping cylinder.

3. The clamping unit of claim 1, further comprising a further said clamping cylinder, wherein the compensating cylinder is disposed between the clamping cylinders in midsection of the moving platen.

4. The clamping unit of claim 1, wherein the connection includes a connection line extending between the piston chamber of the clamping cylinder and the compensating chamber of the compensating cylinder, and a shut-off valve disposed in the connection line.

5. The clamping unit of claim 1, wherein the clamping cylinder and the clamping piston as well as the compensating cylinder and the compensating piston are constructed such that a change in volume in the compensating chamber is in inverse relationship to a change in volume in the piston chamber of the clamping cylinder, when the moving platen is moved.

6. The clamping unit of claim 5, wherein the change in volume in the compensating chamber is substantially inversely identical to the change in volume in the piston chamber of the clamping cylinder.

7. The clamping unit of claim 1, wherein the clamping piston and the compensating piston are firmly coupled to one another.

8. The clamping unit of claim 7, wherein the clamping piston and the compensating piston are fixedly secured to the moving platen.

9. The clamping unit of claim 1, further comprising a multiway valve for selectively connecting the piston chamber of the clamping cylinder via a pressure line to a pressure source to generate a clamping pressure, a tank, or for isolation.

10. The clamping unit of claim 1, wherein the clamping cylinder has a further piston chamber which is selectively connectable via a supply line to a pressure source to implement an opening movement, or to a tank.

11. The clamping unit of claim 1, wherein the compensating cylinder has an end cover, said drive mechanism being mounted to the end cover and to the compensating piston.

12. The clamping unit of claim 1, wherein the drive mechanism includes an active piston.

13. The clamping unit of claim 12, wherein the active piston is hydraulically operated.

14. The clamping unit of claim 12, wherein the compensating cylinder has a cylinder wall for attachment of the active piston, said compensating piston defining an active piston chamber for receiving the active piston.

15. The clamping unit of claim 14, wherein the clamping cylinder has a further piston chamber which is selectively connectable via a supply line to a pressure source for implementing an opening movement, or to a tank, and further comprising a multiway valve for selectively connecting a feed line to the active piston chamber for the active piston with a pressure source and the supply line to the further piston chamber of the clamping cylinder to the tank, or the supply line to the pressure source and the feed line to the tank, or the feed line as well as the supply line to the tank.

16. The clamping unit of claim 1, wherein the drive mechanism is a spindle drive comprised of a spindle nut and a spindle which is in engagement with the spindle nut.

17. The clamping unit of claim 16, wherein the spindle is arranged on the compensating piston, and the spindle nut is rotatably supported on an end cover of the compensating cylinder.

18. The clamping unit of claim 16, wherein the spindle is rotatably supported on an end cover of the compensating cylinder and the spindle nut is arranged on the compensating piston, said compensating piston including a recess for receiving the spindle.

19. The clamping unit of claim 17, wherein at least one of the spindle and spindle nut is mounted with play.

20. The clamping unit of claim 19, further comprising an annular spring for mounting the spindle with play upon the compensating piston.

21. The clamping unit of claim 19, further comprising a bearing constructed for so supporting the spindle nut as to allow a slight shift of the spindle nut in axial direction.

22. The clamping unit of claim 16, wherein the spindle drive includes an electric motor for driving the spindle or the spindle nut.

23. The clamping unit of claim 22, wherein the electric motor is a servo motor.

24. The clamping unit of claim 22, wherein the electric motor is a direct drive.

25. The clamping unit of claim 22, wherein the electric motor is mounted to an end cover of the compensating cylinder.

26. The clamping unit of claim 22, further comprising a pump flange-mounted to the electric motor for producing a clamping force.

27. The clamping unit of claim 26, wherein the pump is a variable capacity pump.

28. A method of operating a clamping unit of an injection molding machine having a moving platen, comprising the step of directly fluidly connecting a piston chamber of a clamping cylinder of the clamping unit with a compensating chamber of a compensating cylinder of the clamping unit to allow fluid displaced from one of the piston chamber and the compensating chamber to substantially flow to the other one of the piston chamber and the compensating chamber, when the moving platen is moved.

29. The method of claim 28, further comprising the steps of cutting a fluid communication between the piston chamber of the clamping cylinder and the compensating chamber of the compensating cylinder, and setting the piston chamber of the clamping cylinder under pressure during a locking phase of the clamping unit.

30. The method of claim 28, further comprising the step of setting a further piston chamber of the clamping cylinder under pressure when opening the clamping unit.

31. The method of claim 28, further comprising the steps of setting an active piston chamber under pressure, when closing the clamping unit, and connecting the active piston chamber to a tank, when opening the clamping unit.

32. The method of claim 28, further comprising the step of opening and closing the clamping unit by means of a spindle drive comprised of a spindle and spindle nut.
